(19) United States
(12) Patent Application Publication
(10) Pub. No.: US 2017/0080292 A1
(43) Pub. Date: Mar. 23, 2017

(54) GOLF BALLS INCORPORATING CROSSLINKED POLYMER COMPOSITIONS

(71) Applicant: Acushnet Company, Fairhaven, MA (US)

(72) Inventors: Michael J. Sullivan, Old Lyme, CT (US); Mark L. Binette, Mattapoisett, MA (US); David A. Bulpett, Boston, MA (US); Robert Blink, Newport, RI (US)

(73) Assignee: Acushnet Company, Fairhaven, MA (US)

(21) Appl. No.: 15/367,474

(22) Filed: Dec. 2, 2016

Related U.S. Application Data
(63) Continuation-in-part of application No. 14/525,753, filed on Oct. 28, 2014.
Application No. 14/525,753 is a continuation-in-part of application No. 15/235,510, filed on Aug. 12, 2016.
Application No. 15/235,510 is a division of application No. 14/490,976, filed on Sep. 19, 2014, now Pat. No. 9,415,273.

(51) Int. Cl. A63B 37/00; C08F 220/06

(52) U.S. Cl. CPC A63B 37/0051; A63B 37/0062; A63B 37/0063; A63B 37/0039; A63B 37/0043; A63B 37/0044; A63B 37/0076; A63B 37/0061; A63B 37/0031; A63B 37/0092; C08F 220/06

(57) ABSTRACT

Golf ball incorporating polymer composition comprising: (i) a reaction mixture of ethylene-acid copolymer and C₃₋₈ α, β-ethylenically unsaturated carboxylic acid(s); and (ii) poly-hydroxy crosslinking agent(s) such as polyvinyl alcohol, diols, glycols, sugar alcohols, and/or glycerols. Concentration of poly-hydroxy crosslinking agent(s) in polymer composition may be up to about 10% (or up to about 5%, or from 0.1% to about 2.5%, or from about 0.05% to 0.95%), by weight, based on 100% total weight of polymer composition. Reaction mixture may further comprise cation source and optionally organic acid(s) or salt thereof. Reaction mixture or polymer composition may include adjuvant(s). such as a silane compound, for example N-(2-aminoethyl-3 aminopropyl)trimethoxysilane and/or 3-glycidoxypropyl trimethoxysilane, in concentration of from 0.025% to 1.0% by weight, based on 100% total weight of reaction mixture or in concentration of up to 10% by weight, based on 100% total weight of the polymer composition.

### CROSS-REFERENCE TO RELATED APPLICATIONS

The present application is a continuation-in-part of U.S. patent application Ser. No. 14/525,753, filed Oct. 28, 2014. This application is also a continuation-in-part of co-assigned, co-pending U.S. patent application Ser. No. 15/235,510, filed Aug. 12, 2016, which is a divisional of U.S. patent application Ser. No. 14/490,976, filed Sep. 19, 2014, now U.S. Pat. No. 9,415,273, which is a continuation-in-part of U.S. patent application Ser. No. 14/460,416 filed Aug. 15, 2014, which is a continuation-in-part of U.S. patent application Ser. No. 14/145,578 filed Dec. 31, 2013, which is a continuation-in-part of U.S. patent application Ser. No. 13/323,128, filed Dec. 12, 2011, now U.S. Pat. No. 8,715,112, which is a divisional of U.S. patent application Ser. No. 12/423,921, filed Apr. 15, 2009, now U.S. Pat. No. 8,075,423, which is a continuation-in-part of U.S. patent application Ser. No. 12/407,856, filed Mar. 20, 2009, now U.S. Pat. No. 7,708,656, which is a continuation-in-part of U.S. patent application Ser. No. 11/972,240, filed Jan. 10, 2008, now U.S. Pat. No. 7,722,482. U.S. patent application Ser. No. 12/423,921 is also a continuation-in-part of Ser. No. 12/407,865, filed Mar. 20, 2009, now U.S. Pat. No. 7,713,145, which is a continuation-in-part of U.S. patent application Ser. No. 11/972,240, filed Jan. 10, 2008, now U.S. Pat. No. 7,722,482. The entire disclosure of each related application is hereby incorporated herein by reference.

### FIELD OF THE INVENTION

The present invention relates to golf balls, and more particularly to golf balls having at least one layer of crosslinked polymer material.

### BACKGROUND OF THE INVENTION

Golf ball manufacturers have been able to vary a wide range of playing characteristics, such as compression, velocity, and spin, by altering the composition of the golf ball. Depending on the layer and desired performance, golf ball layers may be constructed with a number of polymeric compositions and blends, ranging from rubber materials, such as balata, polystyrene butadiene, polybutadiene, or polyisoprene, to thermoplastic or thermoset resins such as ionomers, polyolefins, polyamides, polyesters, polyurethanes, polyureas and/or polyurethane/polyurea hybrids, and blends thereof.

In this regard, thermoset polymers such as polybutadiene rubber materials are used extensively by golf ball manufacturers to form centers and other layers with high resiliency. More recently, thermoplastic ionomers, in particular ethylene-based ionomers, have been found to be suitable materials for forming golf ball layers because of their toughness, durability, and wide range of hardness values.

Advantageously, the thermoplasticity of ionomers permits the material to be applied economically via injection or compression molding techniques and may be remolded or otherwise recycled when exposed to heat above certain temperatures. In contrast, thermoset materials are typically permanently and irreversibly transformed into a solid upon cure.

Ionomer properties can be varied greatly by changing aspects of the formulation such as acid content, softening comonomer content, degree of neutralization, and/or type of metal ion used in the neutralization. Unfortunately, formulation changes designed to improve resiliency, compression, feel, etc., can sometimes also decrease ease of processability and/or reduce melt flow of the ionomer too much, and/or lessen compatibility thereof with other potential blend materials of the layer. These drawbacks can present limitations on the potential uses of currently available thermoplastic ionomers with respect to golf ball layers.

Accordingly, there remains a need for golf ball constructions that cost effectively incorporate ionomeric materials having enhanced resiliency and compression without the processing and/or compatability problems that can arise with conventional modified ionomeric formulations, and meanwhile not sacrificing the durability of conventional ionomers. Golf balls of the present invention and methods for making same address and solve this need.

### SUMMARY OF THE INVENTION

Accordingly, in one embodiment, a golf ball of the invention may comprise at least one layer consisting of a polymer composition comprising (i) a reaction mixture of an acid copolymer comprising ethylene and at least one C₃₋₈ α, β-ethylenically unsaturated carboxylic acid; and (ii) at least one poly-hydroxy crosslinking agent. Without being bound to a particular theory, the hydroxyls in the poly-hydroxy crosslinking agent can react with free acids in the reaction mixture to form a covalent crosslink. The resulting layer of polymer composition has a greater crosslink density than a layer of ionomeric material produced from the reaction mixture and possesses beneficial qualities of thermoset materials such as better resiliency without sacrificing durability and meanwhile can be incorporated in numerous different golf ball constructions easily and cost effectively.

In one embodiment, the at least one poly-hydroxy crosslinking agent may be a dihydroxy crosslinking agent. In one particular embodiment, the at least one poly-hydroxy crosslinking agent is selected from the group consisting of diols, glycols, sugar alcohols, glycerols, or combinations thereof. For example, the diol may be selected from the group consisting of butanediol, propanediol, hexanediol, or combinations thereof. Meanwhile, in another embodiment, the glycol may be selected from propylene glycol or poly(alkylene glycols). A suitable sugar alcohol is sorbitol, and a suitable glycerol is glycerol monostearate. In one embodiment, the at least one poly-hydroxy crosslinking agent may be polyvinyl alcohol. In another embodiment, the at least one poly-hydroxy crosslinking agent may be pentaerythritol.

In one embodiment, the concentration of the at least one poly-hydroxy crosslinking agent in the polymer composition may be up to about 10% by weight, based on 100% total weight of the polymer composition. In another embodiment, the concentration of the at least one poly-hydroxy crosslinking agent in the polymer composition may be up to about 5% by weight, based on 100% total weight of the polymer composition. In yet another embodiment, the concentration of the at least one poly-hydroxy crosslinking agent in the polymer composition may be from 0.1% to about 2.5% by weight, based on 100% total weight of the polymer composition. In still another embodiment, the concentration of the at least one poly-hydroxy cros slinking agent in the polymer composition may be from about 0.05% to 0.95% by weight, based on 100% total weight of the polymer composition.

In some embodiments the use of a catalyst to increase the extent of the esterification reaction, and therefore the degree of crosslinking, is envisioned. Common esterification catalysts such as mineral acids and Lewis acids are suitable. Organic tins, titanates, silicates, and zirconates are also suitable.

The reaction mixture or polymer composition may further comprise at least one adjuvant. In one embodiment, at least one adjuvant may be a silane compound. For example, at least one silane compound may be selected from the group consisting of include N-(2-aminoethyl-3 aminopropyl)trimethoxysilane, 3-glycidoxypropyl trimethoxysilane, or combinations thereof.

In one embodiment, the reaction mixture may comprise at least one silane compound in a concentration of from 0.025% to 1.0% by weight, based on 100% total weight of the reaction mixture. In another embodiment, the polymer composition may comprise at least one silane compound in a concentration of up to 1.0% by weight, based on 100% total weight of the polymer composition.

The C₃₋₈ α, β-ethylenically unsaturated carboxylic acid may be selected from the group consisting of acrylic acid, methacrylic acid, ethacrylic acid, maleic acid, crotonic acid, fumaric acid, itaconic acid, or combinations thereof.

The acid polymer may be selected from the group consisting of ethylene/(meth) acrylic acid/n-butyl acrylate copolymer, ethylene/(meth) acrylic acid/methyl acrylate copolymer, ethylene/(meth) acrylic acid/ethyl (meth) acrylate copolymer, or combinations thereof.

The acid copolymer may further comprise a softening monomer.

In one embodiment, the acid copolymer may further comprise: a cation source present in an amount sufficient to neutralize at least 10% of all acid groups; and optionally at least one organic acid or salt thereof. Alternatively, the reaction mixture may further comprise the cation source present in an amount sufficient to neutralize at least 10% of all acid groups, and optionally at least one organic acid or salt thereof.

In either embodiment, alternatively, the cation source may be present in an amount sufficient to neutralize greater than 10%, or from about 35% to about 55% of all acid groups; or present in an amount sufficient to neutralize from greater than about 55% to about 70% of all acid groups; or present in an amount sufficient to neutralize at least 90% of all acid groups; or present in an amount sufficient to neutralize at least 100% of all acid groups.

In a particular embodiment, the at least one layer may be an inner core of a core assembly and has an outer surface hardness (H_{inner core surface}) and a center hardness (H_{inner core center}), the H_{inner core surface} being different than the H_{inner core center} to provide a first hardness gradient. An outer core layer of the core assembly comprises a thermoset rubber composition and has an outer surface hardness (H_{outer surface of OC}) and a midpoint hardness (H_{midpoint of OC}), the H_{outer surface of OC} being different than the H_{midpoint of OC} to provide a second hardness gradient. The center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

In one such construction, the H_{inner core surface} may be greater than the H_{inner core center} such that the first hardness gradient is a positive hardness gradient; and the H_{outer surface of OC} may be greater than the H_{midpoint of OC} such that the second hardness gradient is a positive hardness gradient.

In another such construction, the H_{inner core surface} may be greater than the H_{inner core center} such that the first hardness gradient is a positive hardness gradient; and the H_{outer surface of OC} may be the same as or less than the H_{midpoint of OC} such that the second hardness gradient is a zero or negative hardness gradient.

In yet another such construction, the H_{inner core surface} may be the same as or less than the H_{inner core center} such that the first hardness gradient is a zero or negative hardness gradient, and the H_{outer surface of OC} may be greater than the H_{midpoint of OC} such that the second hardness gradient is a positive hardness gradient.

In a different construction, the at least one layer may be an outer core layer of a core assembly and has an outer surface hardness (H_{outer surface of OC}) and a midpoint hardness (H_{midpoint of OC}), wherein the H_{outer surface of OC} is greater than the H_{midpoint of OC} to provide a positive hardness gradient. The outer core layer is disposed about an inner core of the core assembly, the inner core comprising a thermoplastic material and having an outer surface hardness (H_{inner core surface}) and a center hardness (H_{inner core center}), wherein the H_{inner core surface} is greater than the H_{inner core center} to provide a positive hardness gradient. Meanwhile, the center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

In one specific such construction, the at least one layer may be a molded sphere having a Coefficient of Restitution of at least about 0.750 and a Shore C surface hardness of from about 10 to about 75. The molded sphere may comprise a core, surrounded by a cover layer having surface hardness of about 60 Shore D or less. Alternatively, the molded sphere may comprise a core, surrounded by a cover comprising an inner cover layer and an outer cover layer, the inner cover layer having a material hardness of about 70 Shore D or less, and the outer cover layer having a material hardness of from about 20 Shore D to about 75 Shore D.

In another embodiment, the molded sphere may be a core, surrounded by a cover comprising an inner cover layer and an outer cover layer, the inner cover layer having a material hardness of from about 20 Shore D to about 75 Shore D, and the outer cover layer having a material hardness of about 70 Shore D or less.

In a different embodiment, the at least one layer may comprise a polymer composition consisting of (i) a reaction mixture of an acid copolymer comprising ethylene and at least one C₃₋₈ α, β-ethylenically unsaturated carboxylic acid; and (ii) at least one poly-hydroxy crosslinking agent. In yet a different embodiment, the at least one layer may consist of a polymer composition consisting of (i) a reaction mixture of an acid copolymer comprising ethylene and at least one C₃₋₈ α, β-ethylenically unsaturated carboxylic acid; and (ii) at least one poly-hydroxy crosslinking agent. In still a different embodiment, the at least one layer may comprise a polymer composition comprising(i) a reaction mixture of an acid copolymer comprising ethylene and at least one C₃₋₈ α, β-ethylenically unsaturated carboxylic acid; and (ii) at least one poly-hydroxy crosslinking agent.

The invention also relates to methods for making a golf ball of the invention having at least one layer of polymer composition. In one embodiment, the method may comprise: (i) forming at least one molded ionomeric layer consisting of an ionomeric composition comprising a reaction mixture of an acid copolymer comprising ethylene and at least one C₃₋₈ α, β-ethylenically unsaturated carboxylic acid; and (ii) exposing the at least one molded ionomeric layer to at least one poly-hydroxy crosslinking agent. The exposing step can include but is not limited to coating, spraying, or dusting the at least one layer with the at least one poly-hydroxy crosslinking agent; or rolling, dipping, or soaking the at least one layer in the at least one poly-hydroxy crosslinking agent.

In a different embodiment, the method of making a golf ball of the invention may comprise (i) forming a reaction mixture of an acid copolymer comprising ethylene and at least one C₃₋₈ α, β-ethylenically unsaturated carboxylic acid; (ii) mixing at least one poly-hydroxy crosslinking agent with the reaction mixture and forming a polymer composition; and (iii) forming the polymer composition into a golf ball layer having a spherical outer surface. The layer may be a sphere and/or a layer that surrounds a subassembly. The subassembly may comprise one or more inner layers such as a spherical inner core; and/or a core comprising an inner core and an outer core layer; and/or an intermediate layer disposed about a core; and/or an inner cover layer disposed about any number of inner layers, and even a coating layer disposed about a layer or between two golf ball layers.

### DETAILED DESCRIPTION OF THE INVENTION

A golf ball of the invention incorporates at least one layer of polymer composition that can be incorporated in numerous different golf ball constructions cost effectively. The polymer composition can comprise or consist of both a “reaction mixture”, as defined herein, and at least one poly-hydroxy crosslinking agent. Hydroxyls in the poly-hydroxy crosslinking agent can react with free acids in the reaction mixture to form a covalent crosslink. Once in the desired form or layer, the uncured reaction mixture and crosslinking agent may be cured in a similar manner as a thermoset material. The resulting golf ball layer has a greater crosslink density than a layer of ionomeric material produced from the reaction mixture and possesses beneficial qualities of thermoset materials such as better resiliency (e.g., coefficient of restitution (CoR)) without sacrificing beneficial characteristics of conventional thermoplastic ionomeric materials such as durability.

The crosslink density of a layer of polymer composition can be measured by Dynamic Mechanical Analysis, and is proportional to the modulus in the ‘rubbery plateau’ region between the glass transition and the melt. In some embodiments, the layer of polymer composition (reaction mixture and at least one poly-hydroxy crosslinking agent, combined) will have a modulus in the rubbery plateau region that is at least 2% greater, or at least 5% greater, or at least 10% greater, or at least 20% greater, or at least 25% greater, or at least 40% greater, or at least 50% greater than the modulus in the rubbery plateau region of an ionomeric material comprised of the reaction mixture only.

In addition, the resulting polymer composition provides for improved stability of physical properties over time and at elevated temperatures. Thus, a layer of polymer composition in a golf ball of the invention provides an improvement over traditional thermoplastic ionomeric golf ball layers that may be used in any or all of core layers, intermediate layers, cover layers, and/or even coating layers.

### Layer of Polymer Composition

Advantageously, the at least one layer in a golf ball of the invention incorporates a polymer composition comprising an otherwise thermoplastic reaction mixture that has been covalently crosslinked with at least one poly-hydroxy crosslinking agent.

(i) Reaction Mixture

The reaction mixture may include at least one acid copolymer, which may be a copolymer of an α-olefin, and at least one C₃₋₈ α, β-ethylenically unsaturated carboxylic acid. For example, the olefin may be ethylene or propylene, preferably ethylene (also referred to as ethylene acid copolymers). Such copolymers are referred to as E/X copolymers, where E is ethylene, and X is a α, β-ethylenically unsaturated carboxylic acid. The term “copolymer”, as used herein, includes polymers having two types of monomers, those having three types of monomers, and those having more than three types of monomers.

Examples of suitable ethylene acid copolymers include but are not limited to ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like.

Preferred α, β-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth) acrylate” means methacrylate and/or acrylate.

The ethylene acid copolymer is used in an amount of at least about 5% by weight based on total weight of polymer composition and is generally present in an amount of about 5% to about 100%, or an amount within a range having a lower limit of 5% or 10% or 20% or 30% or 40% or 50% and an upper limit of 55% or 60% or 70% or 80% or 90% or 95% or 100%. For example, in one embodiment, the concentration of ethylene acid copolymer may be about 40 to about 95 weight percent.

The amount of ethylene in the acid copolymer is typically at least 15 wt. %, or at least 25 wt. %, or at least 40 wt. %, or at least 60 wt. %, based on total weight of the copolymer. The amount of C₃ to C₈ α, β-ethylenically unsaturated mono- or dicarboxylic acid in the acid copolymer is typically from 1 wt. % to 40 wt. %, or from 5 wt. % to 30 wt. %, or from 5 wt. % to 25 wt. %, or from 10 wt. % to 20 wt. %, based on total weight of the copolymer.

When a softening monomer is included, such copolymers are referred to herein as E/X/Y-type copolymers, wherein E is ethylene; X is a C₃ to C₈ α, β-ethylenically unsaturated mono- or dicarboxylic acid; and Y is the softening monomer. The softening monomer is typically an alkyl (meth) acrylate, wherein the alkyl groups have from 1 to 8 carbon atoms. Preferred E/X/Y-type copolymers are those wherein X is (meth) acrylic acid and/or Y is selected from (meth) acrylate, n-butyl (meth) acrylate, isobutyl (meth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate. The amount of optional softening comonomer in the acid copolymer is typically from 0 wt. % to 50 wt. %, or from 5 wt. % to 40 wt. %, or from 10 wt. % to 35 wt. %, or from 20 wt. % to 30 wt. %, based on total weight of the copolymer.

“Low acid” and “high acid” polymer compositions, as well as blends of such ionomers, may be used. In general, low acid ionomers are considered to be those containing 16 wt. % or less of acid moieties, whereas high acid ionomers are considered to be those containing greater than 16 wt. % of acid moieties.

The acidic groups in the acid copolymer may be partially or totally neutralized with a cation source. Suitable cation sources include metal oxides and metal salts, organic amine compounds, ammonium, and combinations thereof. Examples of cation sources include metal oxides and metal salts, wherein the metal is lithium, sodium, potassium, magnesium, calcium, barium, lead, tin, zinc, aluminum, manganese, nickel, chromium, copper, or a combination thereof. The metal salts provide the cations capable of neutralizing (at varying levels) the carboxylic acids of the ethylene acid copolymer and fatty acids, if present, as discussed further below. These include, for example, the sulfate, carbonate, acetate, oxide, or hydroxide salts of lithium, sodium, potassium, magnesium, calcium, barium, lead, tin, zinc, aluminum, manganese, nickel, chromium, copper, or a combination thereof. Preferred metal salts are calcium and magnesium-based salts. High surface area cation sources such as micro and nano-scale particles are preferred. The amount of cation source used in the composition is readily determined based on desired level of neutralization.

For example, the acidic groups in the acid copolymer may be neutralized from about 10% to about 100% with the cation source. In a reaction mixture, wherein the acid groups are partially neutralized, the neutralization level is from about 10% to about 70%, or 20% to 60%, or 30 to 50%. Such reaction mixtures, containing acid groups neutralized to 70% or less, may be referred to as having relatively low neutralization levels.

On the other hand, the reaction mixture may contain acid groups that are highly or fully-neutralized. In these highly neutralized polymers (HNPs), the neutralization level is greater than 70%, or at least 80%, or at least 90%, or at least 100%. In another embodiment, an excess amount of neutralizing agent, that is, an amount greater than the stoichiometric amount needed to neutralize the acid groups, may be used. That is, the acid groups may be neutralized to 100% or greater, for example 110% or 120% or greater. In one embodiment, a high acid ethylene acid copolymer containing about 19 to 20 wt. % methacrylic or acrylic acid is neutralized with zinc and sodium cations to a 95% neutralization level.

In an embodiment wherein the polymer composition comprises a highly neutralized polymer or HNP, the acid polymer may be reacted with a sufficient amount of cation source, in the presence of an organic acid or salt thereof, such that at least about 80 percent, or at least about 90 percent, or at least about 95 percent, or about 100 percent, of all acid groups present are neutralized. In one embodiment, the cation source is present in an amount sufficient to neutralize, theoretically, greater than about 100 percent. For example, the cation source may be present in an amount sufficient to neutralize greater than about 110 percent. In another embodiment, the cation source is present in an amount sufficient to neutralize greater than about 200 percent of the acid groups. In still another embodiment, the cation source is present in an amount sufficient to neutralize greater than about 250 percent of all acid groups present.

In this aspect, the acid polymer can be reacted with the organic acid or salt thereof and the cation source simultaneously, or the acid polymer can be reacted with the organic acid or salt thereof prior to the addition of the cation source. For example, an ethylene α, β-ethylenically unsaturated carboxylic acid copolymer may be melt-blended with an organic acid or a salt of organic acid, and a sufficient amount of a cation source may be added to increase the level of neutralization of all the acid moieties (including those in the acid copolymer and in the organic acid) to greater than about 90 percent, or greater than about 100 percent. However, any method of neutralization available to those of ordinary skill in the art may also be suitably employed.

“Ionic plasticizers” such as organic acids or salts of organic acids, particularly fatty acids, may be added to the reaction mixture if needed. Such ionic plasticizers are used to make conventional ionomer composition more processable as described in Rajagopalan et al., U.S. Pat. No. 6,756,436, the disclosure of which is hereby incorporated by reference. In one embodiment, the reaction mixture, containing acid groups neutralized to 70% or less, does not include a fatty acid or salt thereof, or any other ionic plasticizer. In another embodiment, the reaction mixture, containing acid groups neutralized to greater than 70%, includes an ionic plasticizer, particularly a fatty acid or salt thereof.

For example, the ionic plasticizer, which is particularly effective at improving the processability of highly-neutralized ionomers, may be added in an amount of 10.0 to 50.0 pph.

The organic acids may be aliphatic, mono- or multi-functional (saturated, unsaturated, or multi-unsaturated) organic acids. Salts of these organic acids may also be employed. Suitable fatty acid salts include, for example, metal stearates, laureates, oleates, palmitates, pelargonates, and the like. Fatty acid salts such as zinc stearate, calcium stearate, magnesium stearate, barium stearate, and the like can be used. The salts of fatty acids are generally fatty acids neutralized with metal ions. The metal salts provide the cations capable of neutralizing (at varying levels) the carboxylic acid groups of the fatty acids. Examples include the sulfate, carbonate, acetate and hydroxide salts of metals such as barium, lithium, sodium, zinc, bismuth, chromium, cobalt, copper, potassium, strontium, titanium, tungsten, magnesium, cesium, iron, nickel, silver, aluminum, tin, or calcium, and blends thereof. It is preferred the organic acids and salts be relatively non-migratory (they do not bloom to the surface of the polymer under ambient temperatures) and non-volatile (they do not volatilize at temperatures required for melt-blending).

In addition to the fatty acids and salts of fatty acids discussed above, other suitable plasticizers include, for example, polyethylene glycols, waxes, bis-stearamides, minerals, and phthalates. In another embodiment, an amine or pyridine compound is used, often in addition to a metal cation. Suitable examples include, for example, ethylamine, methylamine, diethylamine, tert-butylamine, dodecylamine, and the like.

It also is recognized that the polymer composition may contain a blend of two or more ionomers. For example, the reaction mixture may contain a 50/50 wt. % blend of two different highly-neutralized ethylene/methacrylic acid copolymers. In another version, the reaction mixture may contain a blend of one or more ionomers and a maleic anhydride-grafted non-ionomeric polymer. The non-ionomeric polymer may be a metallocene-catalyzed polymer. In another version, the reaction mixture contains a blend of a highly-neutralized ethylene/methacrylic acid copolymer and a maleic anhydride-grafted metallocene-catalyzed polyethylene copolymer. In yet another version, the reaction mixture contains a material selected from the group consisting of highly-neutralized ionomers optionally blended with a maleic anhydride-grafted non-ionomeric polymer; polyester elastomers; polyamide elastomers; and combinations of two or more thereof.

A golf ball layer formed from a polymer composition may include a blend of two or more ionomers that helps impart hardness to the ball. In one embodiment, the at least one layer is formed from a reaction mixture comprising a high acid ionomer. A particularly suitable high acid ionomer is Surlyn 8150® (DuPont). Surlyn 8150® is a copolymer of ethylene and methacrylic acid, having an acid content of 19 wt %, which is 45% neutralized with sodium. In another particular embodiment, the inner cover layer is formed from a composition comprising a high acid ionomer and a maleic anhydride-grafted non-ionomeric polymer. A particularly suitable maleic anhydride-grafted polymer is Fusabond 525D® (DuPont). Fusabond 525D® is a maleic anhydride-grafted, metallocene-catalyzed ethylene-butene copolymer having about 0.9 wt. % maleic anhydride grafted onto the copolymer. A particularly preferred blend of high acid ionomer and maleic anhydride-grafted polymer is 84 wt. %/16 wt. % blend of Surlyn 8150® and Fusabond 525D®. Blends of high acid ionomers with maleic anhydride-grafted polymers are further disclosed, for example, in U.S. Pat. Nos. 6,992,135 and 6,677,401, the entire disclosures of which are hereby incorporated herein by reference.

The at least one layer also may be formed from a reaction mixture comprising a 50/45/5 blend of Surlyn® 8940/Surlyn® 9650/Nucrel® 960, such that the polymer composition has a material hardness of from 80 to 85 Shore C. In yet another version, the at least one layer is formed from a polymer composition comprising a 50/25/25 blend of Surlyn® 8940/Surlyn® 9650/Surlyn® 9910, having a material hardness of about 90 Shore C. In another example, the at least one layer also may be formed from a composition comprising a 50/50 blend of Surlyn® 8940/Surlyn® 9650, having a material hardness of about 86 Shore C. A polymer composition comprising a 50/50 blend of Surlyn® 8940 and Surlyn® 7940 also may be used. Surlyn® 8940 is an E/MAA copolymer in which the MAA acid groups have been partially neutralized with sodium ions. Surlyn® 9650 and Surlyn® 9910 are two different grades of E/MAA copolymer in which the MAA acid groups have been partially neutralized with zinc ions. Nucrel® 960 is an E/MAA copolymer resin nominally made with 15 wt. % methacrylic acid.

The reaction mixture may further comprise at least one adjuvant such as silane compound. Examples of silane compounds include N-(2-aminoethyl-3 aminopropyl)trimethoxysilane, 3-glycidoxypropyl trimethoxysilane, or combinations thereof. In one embodiment, the reaction mixture may comprise at least one silane compound in a concentration of from 0.025% to 1.0% by weight, based on 100% total weight of the reaction mixture.

Specific non-limiting examples of suitable acid copolymers and/or reaction mixtures and/or partial ingredients of reactions mixtures are set forth in TABLES 1, 3, 5, 7 and accompanying related properties tables of parent U.S. patent application Ser. No. 15/235,510, filed Aug. 12, 2016, which is a divisional of U.S. patent application Ser. No. 14/490,976, filed Sep. 19, 2014, now U.S. Pat. No. 9,415,273, each which is hereby incorporated by reference herein in its entirety.

In another embodiment of the present invention, the acid copolymers may be blended with non-acid polymers. For example, an E/X copolymer may be blended with an E/Y copolymer. In this aspect, the E/X copolymer, where E is ethylene and X is a α,β-ethylenically unsaturated carboxylic acid, is blended with the E/Y copolymer, where E is ethylene and Y is a softening comonomer, such as alkyl acrylate and methacrylate, where the alkyl groups have from 1 to 8 carbon atoms. Any of the α,β-ethylenically unsaturated carboxylic acids discussed above with regard to the E/X/Y copolymers are suitable for producing the blends.

The acid copolymers may also be blended with other non-acid polymers including elastomeric polymers. For example, an E/X copolymer may be blended with an E/R copolymer. In this aspect, the E/X copolymer, where E is ethylene and X is a α,β-ethylenically unsaturated carboxylic acid, is blended with the E/R copolymer, where E is ethylene and R is a monomer that when polymerized with ethylene creates an elastomeric polymer. Any of the α,β-ethylenically unsaturated carboxylic acids discussed above with regard to the E/X/Y copolymers are suitable for producing the blends.

Suitable non-acid polymers include, but are not limited to, ethylene-alkyl acrylate polymers, particularly polyethylene-butyl acrylate, polyethylene-methyl acrylate, and polyethylene-ethyl acrylate; metallocene-catalyzed polymers; ethylene-butyl acrylate-carbon monoxide polymers and ethylene-vinyl acetate-carbon monoxide polymers; polyethylene-vinyl acetates; ethylene-alkyl acrylate polymers containing a cure site monomer; ethylene-propylene rubbers and ethylene-propylene-diene monomer rubbers; olefinic ethylene elastomers, particularly ethylene-octene polymers, ethylene-butene polymers, ethylene-propylene polymers, and ethylene-hexene polymers; styrenic block copolymers; polyester elastomers; polyamide elastomers; polyolefin rubbers, particularly polybutadiene, polyisoprene, and styrene-butadiene rubber; and thermoplastic polyurethanes. In a preferred embodiment, the non-acid polymers include polyolefins, polyamides, polyesters, polyethers, polyurethanes, metallocene-catalyzed polymers, single-site catalyst polymerized polymers, ethylene propylene rubber, ethylene propylene diene rubber, styrenic block copolymer rubbers, and alkyl acrylate rubbers.

Additional suitable non-acid polymers are disclosed, for example, in paragraph [0054] of parent U.S. patent application Ser. No. 15/235,510, filed Aug. 12, 2016, which is a divisional of U.S. patent application Ser. No. 14/490,976, filed Sep. 19, 2014, now U.S. Pat. No. 9,415,273, each which is hereby incorporated by reference herein in its entirety. In one embodiment, the non-acid polymers may be present in the reaction mixture in an amount of about 5 weight percent to about 80 weight percent, or about 10 weight percent to about 40 weight percent, or about 15 weight percent to about 25 weight percent.

The reaction mixture may optionally contain one or more melt flow modifiers. The amount of melt flow modifier in the composition is readily determined such that the melt flow index of the composition is at least 0.1 g/10 min, or from 0.5 g/10 min to 10.0 g/10 min, or from 1.0 g/10 min to 6.0 g/10 min, as measured using ASTM D-1238, condition E, at 190° C., using a 2160 gram weight.

Suitable melt flow modifiers include, but are not limited to, the high molecular weight organic acids and salts thereof disclosed above, polyamides, polyesters, polyacrylates, polyurethanes, polyethers, polyureas, polyhydric alcohols, and combinations thereof. Also suitable are the non-fatty acid melt flow modifiers.

The reaction mixture, or polymer composition as a whole, may also optionally include additives, fillers, and combinations thereof. In one embodiment, the additives and/or fillers may be present in an amount of from 0 weight percent to about 50 weight percent, based on the total weight of the composition. In another embodiment, the additives and/or fillers may be present in an amount of from about 5 weight percent to about 30 weight percent, based on the total weight of the composition. In still another embodiment, the additives and/or fillers may be present in an amount of from about 10 weight percent to about 20 weight percent, based on the total weight of the composition.

A wide variety of fillers are available, and some of these fillers may be used to adjust the specific gravity of the composition as needed. In particular, fillers such as particulates, fibers, or flakes are suitable. Other examples of fillers include aluminum oxide, zinc oxide, tin oxide, barium sulfate, zinc sulfate, calcium oxide, calcium carbonate, zinc carbonate, barium carbonate, tungsten, tungsten carbide, and lead silicate fillers. Also, silica, fumed silica, and precipitated silica, such as those sold under the tradename, HISIL™ from PPG Industries, carbon black, carbon fibers, and nano-scale materials such as nanotubes, nanoflakes, nanofillers, and nanoclays may be used. Other additives and fillers include, but are not limited to, chemical blowing and foaming agents, optical brighteners, coloring agents, fluorescent agents, whitening agents, UV absorbers, light stabilizers, defoaming agents, processing aids, antioxidants, stabilizers, softening agents, fragrance components, plasticizers, impact modifiers, titanium dioxide, acid copolymer wax, surfactants, rubber regrind (recycled core material), clay, mica, talc, glass flakes, milled glass, and mixtures thereof. Suitable additives are more fully described in, for example, Rajagopalan et al., U.S. Patent Application Publication No. 2003/0225197, the entire disclosure of which is hereby incorporated herein by reference. In a particular embodiment, the total amount of additive(s) and filler(s) present in the final polymer composition is 15 wt. % or less, or 12 wt. % or less, or 10 wt. % or less, or 9 wt. % or less, or 6 wt. % or less, or 5 wt. % or less, or 4 wt. % or less, or 3 wt. % or less, based on the total weight of the polymer composition.

(ii) Poly-Hydroxy Crosslinking Agent

The at least one poly-hydroxy crosslinking agent may, for example, be a dihydroxy crosslinking agent. In one particular embodiment, the at least one poly-hydroxy crosslinking agent may be at least one of diols, glycols, sugar alcohols, glycerols, or combinations thereof. Examples of diols include but are not limited to butanediol, propanediol, hexanediol, or combinations thereof. Meanwhile, examples of glycols include propylene glycol or poly(alkylene glycols). A suitable sugar alcohol is sorbitol, and a suitable glycerol is glycerol monostearate. In one embodiment, at least one poly-hydroxy crosslinking agent may be polyvinyl alcohol. In another embodiment, the at least one poly-hydroxy crosslinking agent may be pentaerythritol.

The concentration of the at least one poly-hydroxy crosslinking agent in the reaction mixture may be up to about 10% by weight, based on 100% total weight of the reaction mixture. In other embodiments, the concentration of the at least one poly-hydroxy cros slinking agent in the reaction mixture may be up to about 5% by weight, or from 0.1% to about 2.5% by weight, or from about 0.05% to 0.95% by weight, with each being based on 100% total weight of the reaction mixture.

Advantageously, the resulting layer of polymer composition may be made in several different ways. For example, in one embodiment, a molded ionomeric layer of an ionomeric composition comprising a reaction mixture of at least ethylene-acid copolymer(s) and C₃₋₈ α, β-ethylenically unsaturated carboxylic acid(s) may be exposed to the poly-hydroxy crosslinking agent(s) at temperatures below that needed for crosslinking.

In another embodiment, a reaction mixture at least of ethylene-acid copolymer(s) and C₃₋₈ α, β-ethylenically unsaturated carboxylic acid(s) may be mixed or otherwise combined with the poly-hydroxy crosslinking agent(s), followed by molding into a golf ball layer of polymer composition having a spherical outer surface.

In a particular example, the poly-hydroxy crosslinking agent(s) may include at least PEG 600 and/or PEG 2000. PEG, or polyethylene glycol, has the general formula HO—(CH₂CH₂O)n-H and may have molecular weights from 200 to tens of thousands, with the numerical designation of a PEG generally indicating its molecular weight. Advantageously, PEGs are generally recognized as safe ingredients.

In some embodiments a catalyst may be used to increase the extent of the esterification reaction, and therefore the degree of crosslinking. Common esterification catalysts such as mineral acids and Lewis acids are suitable. Organic tins, titanates, silicates, and zirconates are also suitable.

(iii) Methods of Forming the Composition

The present invention also explores the methods of making a golf ball of the invention having at least one layer of polymer composition. In one embodiment, the method may comprise: (i) forming at least one molded ionomeric layer consisting of an ionomeric composition comprising a reaction mixture of an acid copolymer comprising ethylene and at least one C₃₋₈ α, β-ethylenically unsaturated carboxylic acid; and (ii) exposing the at least one molded ionomeric layer to at least one poly-hydroxy crosslinking agent. The exposing step can include but is not limited to coating, spraying, or dusting the at least one layer with the at least one poly-hydroxy crosslinking agent; or rolling, dipping, or soaking the at least one layer in the at least one poly-hydroxy crosslinking agent.

In a different embodiment, the method of making a golf ball of the invention may comprise (i) forming a reaction mixture of an acid copolymer comprising ethylene and at least one C₃₋₈ α, β-ethylenically unsaturated carboxylic acid; (ii) mixing at least one poly-hydroxy crosslinking agent with the reaction mixture and forming a polymer composition; and (iii) forming the polymer composition into a golf ball layer having a spherical outer surface. The layer may be a sphere and/or a layer that surrounds a subassembly. The subassembly may comprise one or more inner layers such as a spherical inner core; and/or a core comprising an inner core and an outer core layer; and/or an intermediate layer disposed about a core; and/or an inner cover layer disposed about any number of inner layers, and even a coating layer disposed about a layer or between two golf ball layers.

The acid copolymers of the present invention may be prepared from “direct” acid copolymers, copolymers polymerized by adding all monomers simultaneously, or by grafting at least one acid-containing monomer onto an existing polymer.

Since the reaction mixture can be produced at relatively low extrusion temperatures, the thermoplastic reaction mixture may be blended, and later molded, with the poly-hydroxy crosslinking agent(s) without setting off the cure. This allows for the crosslinking of the ionomers/HNPs, which in turn, provides golf ball layers formed from the crosslinked ionomers/HNPs having higher resiliency and compression values. In addition, the crosslinked ionomers/HNP's improved high temperature stability facilitates the over-molding of an adjacent layer of either a thermoset or thermoplastic without distorting, melting, or deforming the ionomers/HNP layer due to the temperatures required to mold the “over layer.”

The methods of making the ionomers/HNPs are not limited by any particular method or equipment. In one embodiment, the ionomer/HNP is prepared by simultaneously or individually feeding the acid polymer, optional melt flow modifier(s), and optional additive(s)/filler(s) into a melt extruder, such as a single or twin screw extruder. A suitable amount of cation source is then added such that the desired percent of all acid groups present are neutralized. The acid polymer may be at least partially neutralized prior to the above process. The components are intensively mixed prior to being extruded as a strand from the die-head.

After the ionomer/HNP is prepared, the ionomer/HNP may be blended with the poly-hydroxy crosslinking agent(s). In one embodiment, the ionomer/HNP and the poly-hydroxy crosslinking agent(s) are blended in an extruder to form a blended composition. In another embodiment, the ionomer/HNP, poly-hydroxy crosslinking agent(s) and additive(s), adjuvant(s) and/or filler(s), etc. are blended in an extruder to form a blended composition. The blended composition may then be formed into pellets such that the material is pelletized without setting off the cure. The resulting polymer composition can be maintained in this state until molding is desired.

Alternatively, ionomer/HNP pellets of may be exposed to poly-hydroxy crosslinking agent(s) (such as soaked in a liquid thereof) prior to the molding process. Soaking the pellets in liquid poly-hydroxy crosslinking agent(s) prior to the molding process allows for the introduction of the liquid at room temperature and allows for very accurate metering of the liquid into the solid. In this aspect of the present invention, there is very little, if any, loss due to volatilization. If necessary, further additives, such as those discussed above, may be added and uniformly mixed before initiation of the molding process. The blend is then injected into a golf ball mold. Once in desired form or layer, the uncured blend of ionomer/HNP and poly-hydroxy crosslinking agent(s), is cured in a similar manner as thermoset materials. Upon curing, the blend forms a cured golf ball layer. The cured golf ball layer may include a core layer, an intermediate layer, a cover layer, or combinations thereof. Once again, esterification catalysts such as mineral acids, Lewis acids, organic tins, titanates, silicates, and/or zirconates may be used to increase the extent of the esterification reaction, and therefore the degree of crosslinking.

The golf balls of the invention may be formed using a variety of application techniques. For example, the at least one golf ball layer may be formed using compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials.

The golf balls of the present invention may be painted, coated, or surface treated for further benefits. For example, golf balls may be coated with urethanes, urethane hybrids, ureas, urea hybrids, epoxies, polyesters, acrylics, or combinations thereof in order to obtain an extremely smooth, tack-free surface. If desired, more than one coating layer can be used. The coating layer(s) may be applied by any suitable method known to those of ordinary skill in the art. Any of the golf ball layers may be surface treated by conventional methods including blasting, mechanical abrasion, corona discharge, plasma treatment, and the like, and combinations thereof.

### Golf Ball Construction

Golf balls having various constructions may be made in accordance with this invention. The at least one layer of polymer composition may be a core, intermediate layer, cover, or even a coating layer of the golf ball, each of which may have a single layer or multiple layers. In one embodiment, the at least one layer is a cover layer. In another embodiment, the at least one layer may be a core layer. In yet another embodiment, the at least one layer may be an intermediate layer.

In one version, a one-piece ball is made using the polymer composition as the entire golf ball, excluding any paint or coating and indicia applied thereon. In a second version, a two-piece ball comprising a single core and a single cover layer is made. In a third version, a three-piece golf ball contains a dual-layered core and a single-layered cover. The dual-core includes an inner core (center) and surrounding outer core layer. In another version, a three-piece ball contains a single core layer and two cover layers. In yet another version, a four-piece golf ball contains a dual-core and dual-cover (inner cover layer and outer cover layer).

In yet another construction, a four-piece or five-piece golf ball contains a dual-core; an inner cover layer, an intermediate cover layer, and an outer cover layer. In still another construction, a five-piece ball is made containing a three-layered core with an innermost core layer (or center), an intermediate core layer, and outer core layer, and a two-layered cover with an inner and outer cover layer.

Meanwhile, the dimensions of each golf ball component such as the diameter of the core and respective thicknesses of the intermediate layer (s), cover layer(s) and coating layer(s) may be selected and coordinated for targeting and achieving desired playing characteristics or feel. Golf balls made in accordance with this invention can be of any size, although the USGA requires that golf balls used in competition have a diameter of at least 1.68 inches. For play outside of United States Golf Association (USGA) rules, the golf balls can be of a smaller size. Normally, golf balls are manufactured in accordance with USGA requirements and have a diameter in the range of about 1.68 to about 1.80 inches. Also, the USGA has established a maximum weight of 45.93 g (1.62 ounces) for golf balls. For play outside of USGA rules, the golf balls can be heavier.

The overall diameter of the core and all intermediate layers can be about 80 percent to about 98 percent of the overall diameter of the finished ball. The core may have a diameter ranging from about 0.09 inches to about 1.65 inches. In one embodiment, the diameter of the core of the present invention is about 1.2 inches to about 1.630 inches. For example, when part of a two-piece ball according to invention, the core may have a diameter ranging from about 1.5 inches to about 1.62 inches. In another embodiment, the diameter of the core is about 1.3 inches to about 1.6 inches, or from about 1.39 inches to about 1.6 inches, or from about 1.5 inches to about 1.6 inches. In yet another embodiment, the core has a diameter of about 1.55 inches to about 1.65 inches, or about 1.55 inches to about 1.60 inches.

If the core has multiple layers, such multi-layer cores of the present invention can have an overall diameter within a range having a lower limit of about 1.0 or about 1.3 or about 1.4 or about 1.5 or about 1.6 or about 1.61 inches and an upper limit of about 1.62 inches or about 1.63 inches or about 1.64 inches. In a particular embodiment, the multi-layer core has an overall diameter of about 1.5 inches or about 1.51 inches or about 1.53 inches or about 1.55 inches or about 1.57 inches or about 1.58 inches or about 1.59 inches or about 1.6 inches or about 1.61 inches or about 1.62 inches.

The inner core can have an overall diameter of about 0.5 inches or greater, or about 0.75 inches or greater, or about 0.8 inches or greater, or about 0.9 inches or greater, or about 1.0 inches or greater, or about 1.150 inches or greater, or about 1.25 inches or greater, or about 1.35 inches or greater, or about 1.39 inches or greater, or about 1.45 inches or greater, or an overall diameter within a range having a lower limit of about 0.25 or about 0.5 or about 0.75 or about 0.8 or about 0.9 or about 1.0 or about 1.1 or about 1.15 or about 1.2 inches and an upper limit of about 1.25 or about 1.3 or about 1.35 or about 1.39 or about 1.4 or about 1.44 or about 1.45 or about 1.46 or about 1.49 or about 1.5 or about 1.55 or about 1.58 or about 1.6 inches.

Each optional intermediate core layer may have an overall thickness within a range having a lower limit of about 0.005 inches to about 0.040 inches and an upper limit of about 0.05 inches to about 0.100 inches. The range of thicknesses for an intermediate layer of a golf ball is large because of the vast possibilities when using an intermediate layer, i.e., as an outer core layer, an inner cover layer, a wound layer, a moisture/vapor barrier layer. When used in a golf ball of the present invention, the intermediate layer, or inner cover layer, may have a thickness about 0.3 inches or less. In one embodiment, the thickness of the intermediate layer is from about 0.002 inches to about 0.1 inches, or about 0.01 inches or greater. For example, when part of a three-piece ball or multi-layer ball according to the invention, the intermediate layer and/or inner cover layer may have a thickness ranging from about 0.015 inches to about 0.06 inches. In another embodiment, the intermediate layer thickness is about 0.05 inches or less, or about 0.01 inches to about 0.045 inches.

The cover typically has a thickness to provide sufficient strength, good performance characteristics, and durability. In one embodiment, the cover thickness is from about 0.02 inches to about 0.12 inches, or about 0.1 inches or less. For example, when part of a two-piece ball according to invention, the cover may have a thickness ranging from about 0.03 inches to about 0.09 inches. In another embodiment, the cover thickness is about 0.05 inches or less, or from about 0.02 inches to about 0.05 inches, or from about 0.02 inches to about 0.045 inches.

Coating layers may have a combined thickness, for example, of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μm to about 25 μm, or from about 0.1 μm to about 14 μm, or from about 2 μm to about 9 μm, for example.

Specific examples of suitable constructions having desirable playing characteristics include the following. In one particular embodiment, the at least one layer may be an inner core of a core assembly and has an outer surface hardness (H_{inner core surface}) and a center hardness (H_{inner core center}), the H_{inner core surface} being different than the H_{inner core center} to provide a first hardness gradient. An outer core layer of the core assembly comprises a thermoset rubber composition and has an outer surface hardness (H_{outer surface of OC}) and a midpoint hardness (H_{midpoint of OC}), the H_{outer surface of OC} being different than the H_{midpoint of OC} to provide a second hardness gradient. The center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

And in one such construction, the H_{inner core surface} may be greater than the H_{inner core center} such that the first hardness gradient is a positive hardness gradient; and the H_{outer surface of OC} may be greater than the H_{midpoint of OC} such that the second hardness gradient is a positive hardness gradient.

In another such construction, the H_{inner core surface} may be greater than the H_{inner core center} such that the first hardness gradient is a positive hardness gradient; and the H_{outer surface of OC} may be the same as or less than the H_{midpoint of OC} such that the second hardness gradient is a zero or negative hardness gradient.

In yet another such construction, the H_{inner core surface} may be the same as or less than the H_{inner core center} such that the first hardness gradient is a zero or negative hardness gradient, and the H_{outer surface of OC} may be greater than the H_{midpoint of OC} such that the second hardness gradient is a positive hardness gradient.

In a different particular construction, the at least one layer may be an outer core layer of a core assembly and has an outer surface hardness (H_{outer surface of OC}) and a midpoint hardness (H_{midpoint of OC}), wherein the H_{outer surface of OC} is greater than the H_{midpoint of OC} to provide a positive hardness gradient. The outer core layer is disposed about an inner core of the core assembly, the inner core comprising a thermoplastic material and having an outer surface hardness (H_{inner core surface}) and a center hardness (H_{inner core center}), wherein the H_{inner core surface} is greater than the H_{inner core center} to provide a positive hardness gradient. Meanwhile, the center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

And in one specific such construction, the at least one layer may be a molded sphere having a Coefficient of Restitution of at least about 0.750 and a Shore C surface hardness of from about 10 to about 75. The molded sphere may comprise a core, surrounded by a cover layer having surface hardness of about 60 Shore D or less. Alternatively, the molded sphere may comprise a core, surrounded by a cover comprising an inner cover layer and an outer cover layer, the inner cover layer having a material hardness of about 70 Shore D or less, and the outer cover layer having a material hardness of from about 20 Shore D to about 75 Shore D.

In another embodiment, the molded sphere may be a core, surrounded by a cover comprising an inner cover layer and an outer cover layer, the inner cover layer having a material hardness of from about 20 Shore D to about 75 Shore D, and the outer cover layer having a material hardness of about 70 Shore D or less.

### Composition of Golf Ball Layers Other Than a Layer of Polymer Composition

A golf ball of the invention may otherwise be constructed of any known number of other layers formed from conventional golf ball materials and having any known diameter and/or thickness, hardness, compression and/or other golf ball properties, which, when coordinated with the at least one layer of polymer composition, may target particular desired playing characteristics.

For example, in one particular embodiment of a golf ball of the invention, the innermost golf ball layer of a golf ball of the invention may be a conventional rubber-containing inner core, wherein the base rubber may be selected from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers selected from polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, metallocene-catalyzed elastomers, and plastomers.

Suitable curing processes include, for example, peroxide curing, sulfur curing, radiation, and combinations thereof. In one embodiment, the base rubber is peroxide cured. Organic peroxides suitable as free-radical initiators include, for example, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Peroxide free-radical initiators are generally present in the rubber compositions in an amount within the range of 0.05 to 15 parts, or 0.1 to 10 parts, or 0.25 to 6 parts by weight per 100 parts of the base rubber. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particularly suitable metal salts include, for example, one or more metal salts of acrylates, diacrylates, methacrylates, and dimethacrylates, wherein the metal is selected from magnesium, calcium, zinc, aluminum, lithium, and nickel. In a particular embodiment, the cross-linking agent is selected from zinc salts of acrylates, diacrylates, methacrylates, and dimethacrylates. When the cross-linking agent is zinc diacrylate and/or zinc dimethacrylate, the agent typically is included in the rubber composition in an amount within the range of 1 to 60 parts, or 5 to 50 parts, or 10 to 40 parts, by weight per 100 parts of the base rubber.

In a preferred embodiment, the cross-linking agent used in the rubber composition of the core and epoxy composition of the intermediate layer and/or cover layer is zinc diacrylate (“ZDA”). Adding the ZDA curing agent to the rubber composition makes the core harder and improves the resiliency/CoR of the ball. Adding the same ZDA curing agent epoxy composition makes the intermediate and cover layers harder and more rigid. As a result, the overall durability, toughness, and impact strength of the ball is improved.

Sulfur and sulfur-based curing agents with optional accelerators may be used in combination with or in replacement of the peroxide initiators to cross-link the base rubber. High energy radiation sources capable of generating free-radicals may also be used to cross-link the base rubber. Suitable examples of such radiation sources include, for example, electron beams, ultra-violet radiation, gamma radiation, X-ray radiation, infrared radiation, heat, and combinations thereof.

The rubber compositions may also contain “soft and fast” agents such as a halogenated organosulfur, organic disulfide, or inorganic disulfide compound. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A 95. ZnPCTP is commercially available from eChinaChem Inc. (San Francisco, Calif.). These compounds also may function as cis-to-trans catalysts to convert some cis-1,4 bonds in the polybutadiene to trans-1,4 bonds. Peroxide free-radical initiators are generally present in the rubber compositions in an amount within the range of 0.05 to 10 parts, or 0.1 to 5 parts. Antioxidants also may be added to the rubber compositions to prevent the breakdown of the elastomers. Other ingredients such as accelerators (for example, tetra methylthiurams), processing aids, processing oils, dyes and pigments, wetting agents, surfactants, plasticizers, as well as other additives known in the art may be added to the composition. Generally, the fillers and other additives are present in the rubber composition in an amount within the range of 1 to 70 parts by weight per 100 parts of the base rubber. The core may be formed by mixing and forming the rubber composition using conventional techniques. Of course, embodiments are also envisioned wherein outer layers comprise such rubber-based compositions

However, core layers, intermediate/casing layers, and cover layers may additionally or alternatively be formed from other conventional materials such as an ionomeric material including ionomeric polymers, including highly-neutralized ionomers (HNP). In another embodiment, the intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may also be neutralized. The second polymer component, which may be partially or fully neutralized, preferably comprises ionomeric copolymers and terpolymers, ionomer precursors, thermoplastics, polyamides, polycarbonates, polyesters, polyurethanes, polyureas, polyurethane/urea hybrids, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

Non-limiting examples of suitable ionomers include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Methods of preparing ionomers are well known, and are disclosed, for example, in U.S. Pat. No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat. No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Examples of suitable partially neutralized acid polymers include, but are not limited to, Surlyn® ionomers, commercially available from E. I. du Pont de Nemours and Company; AClyn® ionomers, commercially available from Honeywell International Inc.; and lotek® ionomers, commercially available from Exxon Mobil Chemical Company. Some suitable examples of highly neutralized ionomers (HNP) are DuPont® HPF 1000 and DuPont® HPF 2000, ionomeric materials commercially available from E. I. du Pont de Nemours and Company. In some embodiments, very low modulus ionomer-(“VLMI-”) type ethylene-acid polymers are particularly suitable for forming the HNP, such as Surlyn® 6320, Surlyn® 8120, Surlyn® 8320, and Surlyn® 9320, commercially available from E. I. du Pont de Nemours and Company.

It is meanwhile envisioned that in some embodiments/golf ball constructions, it may be beneficial to also include at least one layer formed from or blended with a conventional isocyante-based material. The following conventional compositions as known in the art may be incorporated to achieve particular desired golf ball characteristics:

(1) Polyurethanes, such as those prepared from polyols and diisocyanates or polyisocyanates and/or their prepolymers, and those disclosed in U.S. Pat. Nos. 5,334,673 and 6,506,851;

(2) Polyureas, such as those disclosed in U.S. Pat. Nos. 5,484,870 and 6,835,794; and

(3) Polyurethane/urea hybrids, blends or copolymers comprising urethane and urea segments such as those disclosed in U.S. Pat. No. 8,506,424.

Suitable polyurethane compositions comprise a reaction product of at least one polyisocyanate and at least one curing agent. The curing agent can include, for example, one or more polyols. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Pat. No. 7,331,878, which is incorporated herein in its entirety by reference.

In general, polyurea compositions contain urea linkages formed by reacting an isocyanate group (—N═C═O) with an amine group (NH or NH₂). The chain length of the polyurea prepolymer is extended by reacting the prepolymer with an amine curing agent. The resulting polyurea has elastomeric properties, because of its “hard” and “soft” segments, which are covalently bonded together. The soft, amorphous, low-melting point segments, which are formed from the polyamines, are relatively flexible and mobile, while the hard, high-melting point segments, which are formed from the isocyanate and chain extenders, are relatively stiff and immobile. The phase separation of the hard and soft segments provides the polyurea with its elastomeric resiliency. The polyurea composition contains urea linkages having the following general structure:

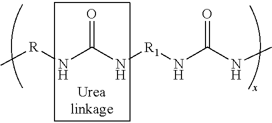

where x is the chain length, i.e., about 1 or greater, and R and R₁ are straight chain or branched hydrocarbon chains having about 1 to about 20 carbon atoms.

A polyurea/polyurethane hybrid composition is produced when the polyurea prepolymer (as described above) is chain-extended using a hydroxyl-terminated curing agent. Any excess isocyanate groups in the prepolymer will react with the hydroxyl groups in the curing agent and create urethane linkages. That is, a polyurea/polyurethane hybrid composition is produced.

In a preferred embodiment, a pure polyurea composition, as described above, is prepared. That is, the composition contains only urea linkages. An amine-terminated curing agent is used in the reaction to produce the pure polyurea composition. However, it should be understood that a polyurea/polyurethane hybrid composition also may be prepared in accordance with this invention as discussed above. Such a hybrid composition can be formed if the polyurea prepolymer is cured with a hydroxyl-terminated curing agent. Any excess isocyanate in the polyurea prepolymer reacts with the hydroxyl groups in the curing agent and forms urethane linkages. The resulting polyurea/polyurethane hybrid composition contains both urea and urethane linkages. The general structure of a urethane linkage is shown below:

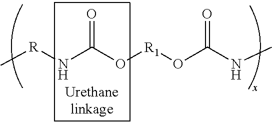

where x is the chain length, i.e., about 1 or greater, and R and R₁ are straight chain or branched hydrocarbon chains having about 1 to about 20 carbon atoms.

There are two basic techniques that can be used to make the polyurea and polyurea/urethane compositions of this invention: a) one-shot technique, and b) prepolymer technique. In the one-shot technique, the isocyanate blend, polyamine, and hydroxyl and/or amine-terminated curing agent are reacted in one step. On the other hand, the prepolymer technique involves a first reaction between the isocyanate blend and polyamine to produce a polyurea prepolymer, and a subsequent reaction between the prepolymer and hydroxyl and/or amine-terminated curing agent. As a result of the reaction between the isocyanate and polyamine compounds, there will be some unreacted NCO groups in the polyurea prepolymer. The prepolymer should have less than 14% unreacted NCO groups. Alternatively, the prepolymer can have no greater than 8.5% unreacted NCO groups, or from 2.5% to 8%, or from 5.0% to 8.0% unreacted NCO groups. As the weight percent of unreacted isocyanate groups increases, the hardness of the composition also generally increases.

Either the one-shot or prepolymer method may be employed to produce the polyurea and polyurea/urethane compositions of the invention; however, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

In the casting process, the polyurea and polyurea/urethane compositions can be formed by chain-extending the polyurea prepolymer with a single curing agent or blend of curing agents as described further below. The compositions of the present invention may be selected from among both castable thermoplastic and thermoset materials. Thermoplastic polyurea compositions are typically formed by reacting the isocyanate blend and polyamines at a 1:1 stoichiometric ratio. Thermoset compositions, on the other hand, are cross-linked polymers and are typically produced from the reaction of the isocyanate blend and polyamines at normally a 1.05:1 stoichiometric ratio. In general, thermoset polyurea compositions are easier to prepare than thermoplastic polyureas.

The polyurea prepolymer can be chain-extended by reacting it with a single curing agent or blend of curing agents (chain-extenders). In general, the prepolymer can be reacted with hydroxyl-terminated curing agents, amine-terminated curing agents, or mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyamine compounds for producing the prepolymer or between prepolymer and curing agent during the chain-extending step. The catalyst can be added to the reactants before producing the prepolymer. Suitable catalysts include, but are not limited to, bismuth catalyst; zinc octoate; stannous octoate; tin catalysts such as bis-butyltin dilaurate, bis-butyltin diacetate, stannous octoate; tin (II) chloride, tin (IV) chloride, bis-butyltin dimethoxide, dimethyl-bis[1-oxonedecyl)oxy]stannane, di-n-octyltin bis-isooctyl mercaptoacetate; amine catalysts such as triethylenediamine, triethylamine, and tributylamine; organic acids such as oleic acid and acetic acid; delayed catalysts; and mixtures thereof. The catalyst is preferably added in an amount sufficient to catalyze the reaction of the components in the reactive mixture. In one embodiment, the catalyst is present in an amount from about 0.001 percent to about 1 percent, or 0.1 to 0.5 percent, by weight of the composition.

The hydroxyl chain-extending (curing) agents are preferably selected from the group consisting of ethylene glycol; diethylene glycol; polyethylene glycol; propylene glycol; 2-methyl-1,3-propanediol; 2-methyl-1,4-butanediol; monoethanolamine; diethanolamine; triethanolamine; monoisopropanolamine; diisopropanolamine; dipropylene glycol; polypropylene glycol; 1,2-butanediol; 1,3-butanediol; 1,4-butanediol; 2,3-butanediol; 2,3-dimethyl-2,3-butanediol; trimethylolpropane; cyclohexyldimethylol; triisopropanolamine; N,N,N′,N′-tetra-(2-hydroxypropyl)-ethylene diamine; diethylene glycol bis-(aminopropyl) ether; 1,5-pentanediol; 1,6-hexanediol; 1,3-bis-(2-hydroxyethoxy) cyclohexane; 1,4-cyclohexyldimethylol; 1,3-bis-[2-(2-hydroxyethoxy) ethoxy]cyclohexane; 1,3-bis-{2-[2-(2-hydroxyethoxy) ethoxy]ethoxy}cyclohexane; trimethylolpropane; polytetramethylene ether glycol (PTMEG), having a molecular weight, for example, of from about 250 to about 3900; and mixtures thereof.

Suitable amine chain-extending (curing) agents that can be used in chain-extending the polyurea prepolymer of this invention include, but are not limited to, unsaturated diamines such as 4,4′-diamino-diphenylmethane (i.e., 4,4′-methylene-dianiline or “MDA”), m-phenylenediamine, p-phenylenediamine, 1,2- or 1,4-bis(sec-butylamino)benzene, 3,5-diethyl-(2,4- or 2,6-) toluenediamine or “DETDA”, 3,5-dimethylthio-(2,4- or 2,6-)toluenediamine, 3,5-diethylthio-(2,4- or 2,6-)toluenediamine, 3,3′-dimethyl-4,4′-diamino-diphenylmethane, 3,3′-diethyl-5,5′-dimethyl4,4′-diamino-diphenylmethane (i.e., 4,4′-methylene-bis(2-ethyl-6-methyl-benezeneamine)), 3,3′-dichloro-4,4′-diamino-diphenylmethane (i.e., 4,4′-methylene-bis(2-chloroaniline) or “MOCA”), 3,3′,5,5′-tetraethyl-4,4′-diamino-diphenylmethane (i.e., 4,4′-methylene-bis(2,6-diethylaniline), 2,2′-dichloro-3,3′,5,5′-tetraethyl-4,4′-diamino-diphenylmethane (i.e., 4,4′-methylene-bis(3-chloro-2,6-diethyleneaniline) or “MCDEA”), 3,3′-diethyl-5,5′-dichloro-4,4′-diamino-diphenylmethane, or “MDEA”), 3,3′-dichloro-2,2′,6,6′-tetraethyl-4,4′-diamino-diphenylmethane, 3,3′-dichloro-4,4′-diamino-diphenylmethane, 4,4′-methylene-bis(2,3-dichloroaniline) (i.e., 2,2′,3,3′-tetrachloro-4,4′-diamino-diphenylmethane or “MDCA”), 4,4′-bis(sec-butylamino)-diphenylmethane, N,N′-dialkylamino-diphenylmethane, trimethyleneglycol-di(p-aminobenzoate), polyethyleneglycol-di(p-aminobenzoate), polytetramethyleneglycol-di(p-aminobenzoate); saturated diamines such as ethylene diamine, 1,3-propylene diamine, 2-methyl-pentamethylene diamine, hexamethylene diamine, 2,2,4- and 2,4,4-trimethyl-1,6-hexane diamine, imino-bis(propylamine), imido-bis(propylamine), methylimino-bis(propylamine) (i.e., N-(3-aminopropyl)-N-methyl-1,3-propanediamine), 1,4-bis(3-aminopropoxy)butane (i.e., 3,3′-[1,4-butanediylbis-(oxy)bis]-1-propanamine), diethyleneglycol-bis(propylamine) (i.e., diethyleneglycol-di(aminopropyl)ether), 4,7,10-trioxatridecane-1,13-diamine, 1-methyl-2,6-diamino-cyclohexane, 1,4-diamino-cyclohexane, poly(oxyethylene-oxypropylene) diamines, 1,3- or 1,4-bis(methylamino)-cyclohexane, isophorone diamine, 1,2- or 1,4-bis(sec-butylamino)-cyclohexane, N,N′-diisopropyl-isophorone diamine, 4,4′-diamino-dicyclohexylmethane, 3,3′-dimethyl-4,4′-diamino-dicyclohexylmethane, 3,3′-dichloro-4,4′-diamino-dicyclohexylmethane, N,N′-dialkylamino-dicyclohexylmethane, polyoxyethylene diamines, 3,3′-diethyl-5,5′-dimethyl-4,4′-diamino-dicyclohexylmethane, polyoxypropylene diamines, 3,3′-diethyl-5,5′-dichloro-4,4′-diamino-dicyclohexylmethane, polytetramethylene ether diamines, 3,3′,5,5′-tetraethyl-4,4′-diamino-dicyclohexylmethane (i.e., 4,4′-methylene-bis(2,6-diethylaminocyclohexane)), 3,3′-dichloro-4,4′-diamino-dicyclohexylmethane, 2,2′-dichloro-3,3′,5,5′-tetraethyl-4,4′-diamino-dicyclohexylmethane, (ethylene oxide)-capped polyoxypropylene ether diamines, 2,2′,3,3′-tetrachloro-4,4′-diamino-dicyclohexylmethane, 4,4′-bis(sec-butylamino)-dicyclohexylmethane; triamines such as diethylene triamine, dipropylene triamine, (propylene oxide)-based triamines (i.e., polyoxypropylene triamines), N-(2-aminoethyl)-1,3-propylenediamine (i.e., N₃-amine), glycerin-based triamines, (all saturated); tetramines such as N,N′-bis(3-aminopropyl)ethylene diamine (i.e., N₄-amine) (both saturated), triethylene tetramine; and other polyamines such as tetraethylene pentamine (also saturated). One suitable amine-terminated chain-extending agent is Ethacure 300™ (dimethylthiotoluenediamine or a mixture of 2,6-diamino-3,5-dimethylthiotoluene and 2,4-diamino-3,5-dimethylthiotoluene.) The amine curing agents used as chain extenders normally have a cyclic structure and a low molecular weight (250 or less).

When the polyurea prepolymer is reacted with amine-terminated curing agents during the chain-extending step, as described above, the resulting composition is essentially a pure polyurea composition. On the other hand, when the polyurea prepolymer is reacted with a hydroxyl-terminated curing agent during the chain-extending step, any excess isocyanate groups in the prepolymer will react with the hydroxyl groups in the curing agent and create urethane linkages to form a polyurea/urethane hybrid.

This chain-extending step, which occurs when the polyurea prepolymer is reacted with hydroxyl curing agents, amine curing agents, or mixtures thereof, builds-up the molecular weight and extends the chain length of the prepolymer. When the polyurea prepolymer is reacted with amine curing agents, a polyurea composition having urea linkages is produced. When the polyurea prepolymer is reacted with hydroxyl curing agents, a polyurea/urethane hybrid composition containing both urea and urethane linkages is produced. The polyurea/urethane hybrid composition is distinct from the pure polyurea composition. The concentration of urea and urethane linkages in the hybrid composition may vary. In general, the hybrid composition may contain a mixture of about 10 to 90% urea and about 90 to 10% urethane linkages. The resulting polyurea or polyurea/urethane hybrid composition has elastomeric properties based on phase separation of the soft and hard segments. The soft segments, which are formed from the polyamine reactants, are generally flexible and mobile, while the hard segments, which are formed from the isocyanates and chain extenders, are generally stiff and immobile.

In an alternative embodiment, the cover layer may comprise a conventional polyurethane or polyurethane/urea hybrid composition. In general, polyurethane compositions contain urethane linkages formed by reacting an isocyanate group (—N═C═O) with a hydroxyl group (OH). The polyurethanes are produced by the reaction of a multi-functional isocyanate (NCO—R—NCO) with a long-chain polyol having terminal hydroxyl groups (OH—OH) in the presence of a catalyst and other additives. The chain length of the polyurethane prepolymer is extended by reacting it with short-chain diols (OH—R′—OH). The resulting polyurethane has elastomeric properties because of its “hard” and “soft” segments, which are covalently bonded together. This phase separation occurs because the mainly non-polar, low melting soft segments are incompatible with the polar, high melting hard segments. The hard segments, which are formed by the reaction of the diisocyanate and low molecular weight chain-extending diol, are relatively stiff and immobile. The soft segments, which are formed by the reaction of the diisocyanate and long chain diol, are relatively flexible and mobile. Because the hard segments are covalently coupled to the soft segments, they inhibit plastic flow of the polymer chains, thus creating elastomeric resiliency.

Suitable isocyanate compounds that can be used to prepare the polyurethane or polyurethane/urea hybrid material are described above. These isocyanate compounds are able to react with the hydroxyl or amine compounds and form a durable and tough polymer having a high melting point. The resulting polyurethane generally has good mechanical strength and cut/shear-resistance. In addition, the polyurethane composition has good light and thermal-stability.

When forming a polyurethane prepolymer, any suitable polyol may be reacted with the above-described isocyanate blends in accordance with this invention. Exemplary polyols include, but are not limited to, polyether polyols, hydroxy-terminated polybutadiene (including partially/fully hydrogenated derivatives), polyester polyols, polycaprolactone polyols, and polycarbonate polyols. In one preferred embodiment, the polyol includes polyether polyol. Examples include, but are not limited to, polytetramethylene ether glycol (PTMEG), polyethylene propylene glycol, polyoxypropylene glycol, and mixtures thereof. The hydrocarbon chain can have saturated or unsaturated bonds and substituted or unsubstituted aromatic and cyclic groups. The polyol may include PTMEG.

In another embodiment, polyester polyols are included in the polyurethane material. Suitable polyester polyols include, but are not limited to, polyethylene adipate glycol; polybutylene adipate glycol; polyethylene propylene adipate glycol; o-phthalate-1,6-hexanediol; poly(hexamethylene adipate) glycol; and mixtures thereof. The hydrocarbon chain can have saturated or unsaturated bonds, or substituted or unsubstituted aromatic and cyclic groups. In still another embodiment, polycaprolactone polyols are included in the materials of the invention. Suitable polycaprolactone polyols include, but are not limited to: 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups. In yet another embodiment, polycarbonate polyols are included in the polyurethane material of the invention. Suitable polycarbonates include, but are not limited to, polyphthalate carbonate and poly(hexamethylene carbonate) glycol. The hydrocarbon chain can have saturated or unsaturated bonds, or substituted or unsubstituted aromatic and cyclic groups. In one embodiment, the molecular weight of the polyol is from about 200 to about 4000.

In a manner similar to making the above-described polyurea compositions, there are two basic techniques that can be used to make the polyurethane compositions of this invention: a) one-shot technique, and b) prepolymer technique. In the one-shot technique, the isocyanate blend, polyol, and hydroxyl-terminated and/or amine-terminated chain-extender (curing agent) are reacted in one step. On the other hand, the prepolymer technique involves a first reaction between the isocyanate blend and polyol compounds to produce a polyurethane prepolymer, and a subsequent reaction between the prepolymer and hydroxyl-terminated and/or amine-terminated chain-extender. As a result of the reaction between the isocyanate and polyol compounds, there will be some unreacted NCO groups in the polyurethane prepolymer. The prepolymer may have less than 14% unreacted NCO groups, or no greater than 8.5% unreacted NCO groups, or from 2.5% to 8%, or from 5.0% to 8.0% unreacted NCO groups. As the weight percent of unreacted isocyanate groups increases, the hardness of the composition also generally increases.

Either the one-shot or prepolymer method may be employed to produce the polyurethane compositions of the invention. In one embodiment, the one-shot method is used, wherein the isocyanate compound is added to a reaction vessel and then a curative mixture comprising the polyol and curing agent is added to the reaction vessel. The components are mixed together so that the molar ratio of isocyanate groups to hydroxyl groups is in the range of about 1.01:1.00 to about 1.10:1.00. The molar ratio can be greater than or equal to 1.05:1.00. For example, the molar ratio can be in the range of 1.05:1.00 to 1.10:1.00. In a second embodiment, the prepolymer method is used. In general, the prepolymer technique is preferred because it provides better control of the chemical reaction. The prepolymer method provides a more homogeneous mixture resulting in a more consistent polymer composition. The one-shot method results in a mixture that is inhomogeneous (more random) and affords the manufacturer less control over the molecular structure of the resultant composition.

The polyurethane compositions can be formed by chain-extending the polyurethane prepolymer with a single curing agent (chain-extender) or blend of curing agents (chain-extenders) as described further below. The compositions of the present invention may be selected from among both castable thermoplastic and thermoset polyurethanes. Thermoplastic polyurethane compositions are typically formed by reacting the isocyanate blend and polyols at a 1:1 stoichiometric ratio. Thermoset compositions, on the other hand, are cross-linked polymers and are typically produced from the reaction of the isocyanate blend and polyols at normally a 1.05:1 stoichiometric ratio. In general, thermoset polyurethane compositions are easier to prepare than thermoplastic polyurethanes.

As discussed above, the polyurethane prepolymer can be chain-extended by reacting it with a single chain-extender or blend of chain-extenders. In general, the prepolymer can be reacted with hydroxyl-terminated curing agents, amine-terminated curing agents, and mixtures thereof. The curing agents extend the chain length of the prepolymer and build-up its molecular weight. Normally, the prepolymer and curing agent are mixed so the isocyanate groups and hydroxyl or amine groups are mixed at a 1.05:1.00 stoichiometric ratio.

A catalyst may be employed to promote the reaction between the isocyanate and polyol compounds for producing the polyurethane prepolymer or between the polyurethane prepolymer and chain-extender during the chain-extending step. The catalyst can be added to the reactants before producing the polyurethane prepolymer. Suitable catalysts include, but are not limited to, the catalysts described above for making the polyurea prepolymer. The catalyst may be added in an amount sufficient to catalyze the reaction of the components in the reactive mixture. In one embodiment, the catalyst is present in an amount from about 0.001 percent to about 1 percent, or 0.1 to 0.5 percent, by weight of the composition.

Suitable hydroxyl chain-extending (curing) agents and amine chain-extending (curing) agents include, but are not limited to, the curing agents described above for making the polyurea and polyurea/urethane hybrid compositions. When the polyurethane prepolymer is reacted with hydroxyl-terminated curing agents during the chain-extending step, as described above, the resulting polyurethane composition contains urethane linkages. On the other hand, when the polyurethane prepolymer is reacted with amine-terminated curing agents during the chain-extending step, any excess isocyanate groups in the prepolymer will react with the amine groups in the curing agent. The resulting polyurethane composition contains urethane and urea linkages and may be referred to as a polyurethane/urea hybrid. The concentration of urethane and urea linkages in the hybrid composition may vary. In general, the hybrid composition may contain a mixture of about 10 to 90% urethane and about 90 to 10% urea linkages.

Those layers of golf balls of the invention comprising conventional thermoplastic or thermoset materials may be formed using a variety of conventional application techniques such as compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entireties.

A method of injection molding using a split vent pin can be found in co-pending U.S. Pat. No. 6,877,974, filed Dec. 22, 2000, entitled “Split Vent Pin for Injection Molding.” Examples of retractable pin injection molding may be found in U.S. Pat. Nos. 6,129,881; 6,235,230; and 6,379,138. These molding references are incorporated in their entirety by reference herein. In addition, a chilled chamber, i.e., a cooling jacket, such as the one disclosed in U.S. Pat. No. 6,936,205, filed Nov. 22, 2000, entitled “Method of Making Golf Balls” may be used to cool the compositions of the invention when casting, which also allows for a higher loading of catalyst into the system.

Conventionally, compression molding and injection molding are applied to thermoplastic materials, whereas RIM, liquid injection molding, and casting are employed on thermoset materials. These and other manufacture methods are disclosed in U.S. Pat. Nos. 6,207,784 and 5,484,870, the disclosures of which are incorporated herein by reference in their entirety.

Castable reactive liquid polyurethanes and polyurea materials may be applied over the inner ball using a variety of application techniques such as casting, injection molding spraying, compression molding, dipping, spin coating, or flow coating methods that are well known in the art. In one embodiment, the castable reactive polyurethanes and polyurea material is formed over the core using a combination of casting and compression molding. Conventionally, compression molding and injection molding are applied to thermoplastic cover materials, whereas RIM, liquid injection molding, and casting are employed on thermoset cover materials.

U.S. Pat. No. 5,733,428, the entire disclosure of which is hereby incorporated by reference, discloses a method for forming a polyurethane cover on a golf ball core. Because this method relates to the use of both casting thermosetting and thermoplastic material as the golf ball cover, wherein the cover is formed around the core by mixing and introducing the material in mold halves, the polyurea compositions may also be used employing the same casting process.

For example, once a polyurea composition is mixed, an exothermic reaction commences and continues until the material is solidified around the core. It is important that the viscosity be measured over time, so that the subsequent steps of filling each mold half, introducing the core into one half and closing the mold can be properly timed for accomplishing centering of the core cover halves fusion and achieving overall uniformity. A suitable viscosity range of the curing urea mix for introducing cores into the mold halves is determined to be approximately between about 2,000 cP and about 30,000 cP, or within a range of about 8,000 cP to about 15,000 cP.

To start the cover formation, mixing of the prepolymer and curative is accomplished in a motorized mixer inside a mixing head by feeding through lines metered amounts of curative and prepolymer. Top preheated mold halves are filled and placed in fixture units using centering pins moving into apertures in each mold. At a later time, the cavity of a bottom mold half, or the cavities of a series of bottom mold halves, is filled with similar mixture amounts as used for the top mold halves. After the reacting materials have resided in top mold halves for about 40 to about 100 seconds, or about 70 to about 80 seconds, a core is lowered at a controlled speed into the gelling reacting mixture.

A ball cup holds the shell through reduced pressure (or partial vacuum). Upon location of the core in the halves of the mold after gelling for about 4 to about 12 seconds, the vacuum is released allowing the core to be released. In one embodiment, the vacuum is released allowing the core to be released after about 5 seconds to 10 seconds. The mold halves, with core and solidified cover half thereon, are removed from the centering fixture unit, inverted and mated with second mold halves which, at an appropriate time earlier, have had a selected quantity of reacting polyurea prepolymer and curing agent introduced therein to commence gelling.

Similarly, U.S. Pat. No. 5,006,297 and U.S. Pat. No. 5,334,673 both also disclose suitable molding techniques that may be utilized to apply the castable reactive liquids employed in the present invention.

However, golf balls of the invention may be made by any known technique to those skilled in the art.

Examples of yet other materials which may be suitable for incorporating and coordinating in order to target and achieve desired playing characteristics or feel include plasticized thermoplastics, polyalkenamer compositions, polyester-based thermoplastic elastomers containing plasticizers, transparent or plasticized polyamides, thiolene compositions, poly-amide and anhydride-modified polyolefins, organic acid-modified polymers, and the like.

### Golf Ball Properties

The properties such as core diameter, intermediate layer and cover layer thickness, hardness, and compression have been found to affect play characteristics such as spin, initial velocity, and feel of the present golf balls.

Hardness

The compositions of the invention may be used in any layer of a golf ball. Accordingly, the golf ball construction, physical properties, and resulting performance may vary depending on the layer(s) of the ball that include the polymer compositions.

The cores included in the golf balls of the present invention may have varying hardnesses depending on the particular golf ball construction. In one embodiment, the core hardness ranges from about 10 Shore C to about 95 Shore C. In another embodiment, the core hardness ranges from about 10 Shore C to about 75 Shore C. In yet another embodiment, the core has a hardness ranging from about 50 Shore C to about 95 Shore C.

The intermediate layers of the present invention may also vary in hardness depending on the specific construction of the ball. In one embodiment, the surface hardness of the intermediate layer may be about 75 Shore D or less, or about 70 Shore D or less, or about 65 Shore D or less, or less than about 65 Shore D, or a Shore D hardness of from about 50 to about 65, or a Shore D hardness of from about 55 to about 60.

As with the core and intermediate layers, the cover hardness may vary depending on the construction and desired characteristics of the golf ball. In one embodiment, the cover may have a surface hardness of about 75 Shore D or less, or about 70 Shore D or less, or about 60 Shore D or less and/or a material hardness of about 60 Shore D or less. In another embodiment, the cover is a dual- or multi-layer cover including an inner or intermediate cover layer and an outer cover layer formed. The inner layer may have a surface hardness of about 70 Shore D or less, or about 65 Shore D or less, or less than about 65 Shore D, or a Shore D hardness of from about 50 to 65, or a Shore D hardness of from about 55 to 60. The outer cover layer may have a surface hardness ranging from about 20 Shore D to about 75 Shore D.

Compression

Compression is an important factor in golf ball design. For example, the compression of the core can affect the ball's spin rate off the driver and the feel. In fact, the compositions and methods of the present invention result in golf balls having increased compressions and ultimately an overall harder ball. The harder the overall ball, the less deformed it becomes upon striking, and the faster it breaks away from the golf club.

As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, “compression” refers to Atti compression and is measured according to a known procedure, using an Atti compression test device, wherein a piston is used to compress a ball against a spring.

Golf balls of the present invention typically have a compression of 40 or greater, or a compression within a range having a lower limit of 50 or 60 and an upper limit of 100 or 120. The core compression may be about 90 or less, or 80 or less, or 70 or less, or 60 or less, or 50 or less, or 40 or less, or 30 or less, or 20 or less, or a compression within a range having a lower limit of 10 or 20 or 30 or 35 or 40 and an upper limit of 50 or 60 or 70 or 80 or 90. In another embodiment, the core may have an overall compression of 40 or greater, or 50 or greater, or 60 or greater, or 70 or greater, or 80 or greater, or a compression within a range having a lower limit of 40 or 50 or 55 or 60 and an upper limit of 80.

Coefficient of Restitution

The coefficient of restitution or CoR of a golf ball is a measure of the amount of energy lost when two objects collide. The CoR of a golf ball indicates its ability to rebound and accounts for the spring-like feel of the ball after striking. As used herein, the term “coefficient of restitution” (CoR) is calculated by dividing the rebound velocity of the golf ball by the incoming velocity when a golf ball is shot out of an air cannon. The CoR testing is conducted over a range of incoming velocities and determined at an inbound velocity of 125 ft/s.

The polymer composition of the present invention demonstrates superior CoR values. Without being bound to any particular theory, it is believed that the reduction in crystallinity, provided by crosslinking the reaction mixture, increases the CoR and durability when used in a golf ball layer. In addition, crosslinking is believed to reduce chain end mobility thereby further improving the CoR at a given compression. Thus, in a particular example, the at least one layer of polymer composition is a molded sphere having a Coefficient of Restitution of at least about 0.750.

The present invention contemplates golf balls having CoRs from about 0.700 to about 0.850 or more at an inbound velocity of about 125 ft/sec. In one embodiment, the CoR is about 0.750 or greater, or about 0.780 or greater. In another embodiment, the ball has a CoR of about 0.800 or greater. In yet another embodiment, the CoR of the balls of the invention is about 0.800 to about 0.815.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended as illustrations of several aspects of the invention. Any equivalent embodiments are intended to be within the scope of this invention. For example, the compositions of the invention may also be used in golf equipment such as putter inserts, golf club heads and portions thereof, golf shoe portions, and golf bag portions. Indeed, various modifications of the invention in addition to those shown and described herein will become apparent to those skilled in the art from the foregoing description. Such modifications are also intended to fall within the scope of the appended claims. All patents and patent applications cited in the foregoing text are expressly incorporate herein by reference in their entirety.

1. A golf ball having at least one layer consisting of a polymer composition comprising:
(i) a reaction mixture of an acid copolymer comprising ethylene and at least one C₃₋₈ α, β-ethylenically unsaturated carboxylic acid; and
(ii) at least one poly-hydroxy crosslinking agent.

2. The golf ball of claim 1, wherein the at least one poly-hydroxy crosslinking agent is a dihydroxy crosslinking agent.

3. The golf ball of claim 1, wherein the at least one poly-hydroxy crosslinking agent is selected from the group consisting of diols, glycols, sugar alcohols, glycerols, or combinations thereof.

4. The golf ball of claim 3, wherein the diol is selected from the group consisting of butanediol, propanediol, or hexanediol.

5. The golf ball of claim 3, wherein the glycol is selected from propylene glycol or poly(alkylene glycols).

6. The golf ball of claim 3, wherein the sugar alcohol is sorbitol.

7. The golf ball of claim 3, wherein the glycerol is glycerol monostearate.

8. The golf ball of claim 1, wherein the at least one poly-hydroxy crosslinking agent is polyvinyl alcohol.

9. The golf ball of claim 1, wherein the at least one poly-hydroxy crosslinking agent is pentaerythritol.

10. The golf ball of claim 1, wherein the concentration of the at least one poly-hydroxy crosslinking agent in the polymer composition is up to about 10% by weight, based on 100% total weight of the polymer composition.

11. The golf ball of claim 1, wherein the concentration of the at least one poly-hydroxy crosslinking agent in the polymer composition is up to about 5% by weight, based on 100% total weight of the polymer composition.

12. The golf ball of claim 1, wherein the concentration of the at least one poly-hydroxy crosslinking agent in the polymer composition is from 0.1% to about 2.5% by weight, based on 100% total weight of the polymer composition.

13. The golf ball of claim 1, wherein the concentration of the at least one poly-hydroxy crosslinking agent in the polymer composition is from about 0.05% to 0.95% by weight, based on 100% total weight of the polymer composition.

14. The golf ball of claim 1, wherein the polymer composition further comprises a catalyst selected from the group consisting of mineral acids, Lewis acids, organic tins, titanates, silicates, zirconates, or combinations thereof.

15. The golf ball of claim 1, wherein the reaction mixture further comprises at least one adjuvant.

16. The golf ball of claim 15, wherein at least one adjuvant is at least one silane compound.

17. The golf ball of claim 16, wherein at least one silane compound is selected from the group consisting of include N-(2-aminoethyl-3-aminopropyl)trimethoxysilane, 3-glycidoxypropyl trimethoxysilane, or combinations thereof.

18. The golf ball of claim 16, wherein the reaction mixture comprises the at least one silane compound in a concentration of from 0.025% to 1.0% by weight, based on 100% total weight of the reaction mixture.

19. The golf ball of claim 1, wherein the C₃₋₈ α, β-ethylenically unsaturated carboxylic acid is selected from the group consisting of acrylic acid, methacrylic acid, ethacrylic acid, maleic acid, crotonic acid, fumaric acid, itaconic acid, or combinations thereof.

20. The golf ball of claim 1, wherein the acid polymer is selected from the group consisting of ethylene/(meth) acrylic acid/n-butyl acrylate copolymer, ethylene/(meth) acrylic acid/methyl acrylate copolymer, ethylene/(meth) acrylic acid/ethyl (meth) acrylate copolymer, or combinations thereof.

21. The golf ball of claim 1, wherein the acid copolymer further comprises a softening monomer.

22. The golf ball of claim 1, wherein the acid copolymer further comprises a cation source present in an amount sufficient to neutralize at least 10% of all acid groups, and optionally at least one organic acid or salt thereof.

23. The golf ball of claim 1, wherein the reaction mixture further comprises a cation source present in an amount sufficient to neutralize at least 10% of all acid groups, and optionally at least one organic acid or salt thereof.

24. The golf ball of claim 22, wherein the cation source is present in an amount sufficient to neutralize from about 35% to about 55% of all acid groups.

25. The golf ball of claim 22, wherein the cation source is present in an amount sufficient to neutralize from greater than about 55% to about 70% of all acid groups.

26. The golf ball of claim 22, wherein the cation source is present in an amount sufficient to neutralize at least 90% of all acid groups.

27. The golf ball of claim 22, wherein the cation source is present in an amount sufficient to neutralize at least 100% of all acid groups.

28. The golf ball of claim 1, wherein the at least one layer is an inner core of a core assembly and has an outer surface hardness (H_{inner core surface}) and a center hardness (H_{inner core center}), the H_{inner core surface} being different than the H_{inner core center} to provide a first hardness gradient; and wherein an outer core layer of the core assembly comprises a thermoset rubber composition and has an outer surface hardness (H_{outer surface of OC}) and a midpoint hardness (H_{midpoint of OC}), the H_{outer surface of OC} being different than the H_{midpoint of OC} to provide a second hardness gradient; such that the center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

29. The golf ball of claim 28, wherein the H_{inner core surface} is greater than the H_{inner core center} such that the first hardness gradient is a positive hardness gradient; and wherein the H_{outer surface of OC} is greater than the H_{midpoint of OC} such that the second hardness gradient is a positive hardness gradient.

30. The golf ball of claim 28, wherein the H_{inner core surface} is greater than the H_{inner core center} such that the first hardness gradient is a positive hardness gradient; and wherein the H_{outer surface of OC} is the same as or less than the H_{midpoint of OC} such that the second hardness gradient is a zero or negative hardness gradient.

31. The golf ball of claim 28, wherein the H_{inner core surface} is the same as or less than the H_{inner core center} such that the first hardness gradient is a zero or negative hardness gradient, and wherein the H_{outer surface of OC} is greater than the H_{midpoint of OC} such that the second hardness gradient is a positive hardness gradient.

32. The golf ball of claim 1, wherein the at least one layer is an outer core layer of a core assembly and has an outer surface hardness (H_{outer surface of OC}) and a midpoint hardness (H_{midpoint of OC}), wherein the H_{outer surface of OC} is greater than the H_{midpoint of OC} to provide a positive hardness gradient; the outer core layer being disposed about an inner core of the core assembly, the inner core comprising a thermoplastic material and having an outer surface hardness (H_{inner core surface}) and a center hardness (H_{inner core center}), wherein the H_{inner core surface} is greater than the H_{inner core center} to provide a positive hardness gradient; and wherein the center hardness of the inner core (H_{inner core center}) is in the range of about 10 Shore C to about 70 Shore C and the outer surface hardness of the outer core layer (H_{outer surface of OC}) is in the range of about 20 Shore C to about 95 Shore C to provide a positive hardness gradient across the core assembly.

33. The golf ball of claim 1, wherein the at least one layer is a molded sphere having a Coefficient of Restitution of at least about 0.750 and a Shore C surface hardness of from about 10 to about 75.

34. The golf ball of claim 33, wherein the molded sphere comprises a core, surrounded by a cover layer having surface hardness of about 60 Shore D or less.

35. The golf ball of claim 33, wherein the molded sphere comprises a core, surrounded by a cover comprising an inner cover layer and an outer cover layer, the inner cover layer having a material hardness of about 70 Shore D or less, and the outer cover layer having a material hardness of from about 20 Shore D to about 75 Shore D.

36. The golf ball of claim 33, wherein the molded sphere comprises a core, surrounded by a cover comprising an inner cover layer and an outer cover layer, the inner cover layer having a material hardness of from about 20 Shore D to about 75 Shore D, and the outer cover layer having a material hardness of about 70 Shore D or less.

37. The golf ball of claim 1, wherein the at least one layer of polymer composition has a greater crosslink density than a layer of ionomeric material formed from the reaction mixture.
